(19) United States
(12) Patent Application Publication
(10) Pub. No.: US 2024/0361571 A1
(43) Pub. Date: Oct. 31, 2024

(54) OPTICAL IMAGING SYSTEM

(71) Applicant: SAMSUNG ELECTRO-MECHANICS CO., LTD., Suwon-si (KR)

(72) Inventors: Jae Hyuk HUH, Suwon-si (KR); So Mi YANG, Suwon-si (KR); You Jin JEONG, Suwon-si (KR); Byung Gi AN, Suwon-si (KR)

(73) Assignee: SAMSUNG ELECTRO-MECHANICS CO., LTD., Suwon-si (KR)

(21) Appl. No.: 18/597,319

(22) Filed: Mar. 6, 2024

(30) Foreign Application Priority Data
Apr. 27, 2023 (KR) 10-2023-0055670

(51) Int. Cl. G02B 9/04; G02B 17/08

(52) U.S. Cl. CPC G02B 9/04; G02B 17/08

(57) ABSTRACT

An optical imaging system includes a first lens group, a reflective member, and a second lens group sequentially arranged along an optical axis. Each of the first lens group and the second lens group includes a plurality of lenses. The first lens group has positive refractive power. An effective diameter of a first lens, among the plurality of lenses in the first lens group, is largest among the plurality of lenses in the first and second lens groups, and 0<DL1P/TTL<0.25 is satisfied, where DL1P is a distance, on the optical axis, from an object-side surface of the first lens in the first lens group to a first surface of the reflective member, and TTL is a distance, on the optical axis, from the object-side surface of the first lens in the first lens group to an imaging surface.

### CROSS-REFERENCE TO RELATED APPLICATIONS

This application claims the benefit under 35 USC 119(a) of Korean Patent Application No. 10-2023-0055670 filed on Apr. 27, 2023, in the Korean Intellectual Property Office, the entire disclosure of which is incorporated herein by reference for all purposes.

### TECHNICAL FIELD

### 1. Field

The following description relates to an optical imaging system.

### 2. Description of the Background

Portable terminals may be equipped with cameras, including an optical imaging system comprising a plurality of lenses to enable video calls and image capture.

Portable terminal cameras may include image sensors with high pixels (e.g., 13 million to 100 million pixels, etc.) to realize image quality clarity.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system, includes a first lens group, a reflective member, and a second lens group sequentially arranged along an optical axis. Each of the first lens group and the second lens group includes a plurality of lenses. The first lens group has positive refractive power. An effective diameter of a first lens, among the plurality of lenses in the first lens group, is largest among the plurality of lenses in the first and second lens groups, and 0<DL1P/TTL<0.25 is satisfied, where DL1P is a distance, on the optical axis, from an object-side surface of the first lens in the first lens group to a first surface of the reflective member, and TTL is a distance, on the optical axis, from the object-side surface of the first lens in the first lens group to an imaging surface.

The first lens group may include the first lens and a second lens arranged sequentially from an object side. One of the first lens and the second lens may have a positive focal length with an Abbe number greater than 50, and another may have a negative focal length with an Abbe number less than 30.

v1−v2>29 may be satisfied, where v1 is the Abbe number of the first lens, and v2 is the Abbe number of the second lens.

The first lens group may include the first lens and a second lens arranged sequentially from an object side, and f1/f2<0.2 may be satisfied, where f1 is a focal length of the first lens, and f2 is a focal length of the second lens.

0<D1/f<0.05 may be satisfied, where D1 is a distance, on the optical axis, between the first lens and the second lens.

f>10 mm may be satisfied, where f is a total focal length of the optical imaging system.

0.5<DL3i/TTL<0.6 may be satisfied, where DL3i is a distance, on the optical axis, from an object-side surface of a forwardmost lens of the second lens group to the imaging surface.

2<TTL/BFL<6 may be satisfied, where BFL is a distance, on the optical axis, from an image-side surface of a rearmost lens of the second lens group to the imaging surface.

1<f/fG1<1.6 may be satisfied, where f is a total focal length of the optical imaging system, and fG1 is a focal length of the first lens group.

0.4<|fG1/fG21|<1.1 may be satisfied, where fG1 is a focal length of the first lens group, and fG2 is a focal length of the second lens group.

Nv50≥2 and Nv28≥3 may be satisfied, where Nv50 is a number of lenses having an Abbe number greater than 50, and Nv28 is a number of lenses having an Abbe number less than 28.

Among the plurality of lenses in the second lens group, two or more lenses arranged sequentially from the object side may have a refractive index of 1.61 or more.

A number of the plurality of lenses in the second lens group may be equal to or greater than a number of the plurality of lenses in the first lens group.

The first lens group may include the first lens and a second lens, and the second lens group may include a third lens, a fourth lens, a fifth lens and a sixth lens.

The first lens may have positive refractive power, and the second lens may have negative refractive power.

In another general aspect. an optical imaging system includes a first lens group comprising a first lens and a second lens; a reflective member; and a second lens group includes a third lens, a fourth lens, a fifth lens and a sixth lens. The first lens group, the reflective member, and the second lens group are sequentially arranged along an optical axis. The first lens has positive refractive power, and the second lens has negative refractive power. An effective diameter of the first lens is largest among lenses of the first and second lens groups. 0<DL1P/TTL<0.25 is satisfied, where DL1P is a distance, on the optical axis, from an object-side surface of the first lens to a first surface of the reflective member, and TTL is a distance, on the optical axis, from the object-side surface of the first lens to an imaging surface. 2<TTL/BFL<6 is satisfied, where BFL is a distance, on the optical axis, from an image-side surface of a rearmost lens of the plurality of lenses in the second lens group to the imaging surface.

v1−v2>29 may be satisfied, where v1 is an Abbe number of the first lens, and v2 is an Abbe number of the second lens.

f1/f2<0.2 may be satisfied, where f1 is a focal length of the first lens, and f2 is a focal length of the second lens.

Other features and aspects will be apparent from the following detailed description, the drawings, and the claims.

### BRIEF DESCRIPTION OF DRAWINGS

FIG. 1 is a structural view of an optical imaging system according to a first embodiment of the present disclosure

FIG. 2 is a view illustrating aberration characteristics of the optical imaging system illustrated in FIG. 1.

FIG. 3 is a structural view of an optical imaging system according to a second embodiment of the present disclosure;

FIG. 4 is a view illustrating aberration characteristics of the optical imaging system illustrated in FIG. 3;

FIG. 5 is a structural view of an optical imaging system according to a third embodiment of the present disclosure;

FIG. 6 is a view illustrating aberration characteristics of the optical imaging system illustrated in FIG. 5;

FIG. 7 is a structural view of an optical imaging system according to a fourth embodiment of the present disclosure;

FIG. 8 is a view illustrating aberration characteristics of the optical imaging system illustrated in FIG. 7;

FIG. 9 is a structural view of an optical imaging system according to a fifth embodiment of the present disclosure;

FIG. 10 is a view illustrating aberration characteristics of the optical imaging system illustrated in FIG. 9;

FIG. 11 is a block diagram of an optical imaging system according to a sixth embodiment of the present disclosure;

FIG. 12 is a view illustrating aberration characteristics of the optical imaging system illustrated in FIG. 11;

FIG. 13 is a structural view of an optical imaging system according to a seventh embodiment of the present disclosure;

FIG. 14 is a view illustrating aberration characteristics of the optical imaging system illustrated in FIG. 13;

FIG. 15 is a structural view of an optical imaging system according to an eighth embodiment of the present disclosure;

FIG. 16 is a view illustrating aberration characteristics of the optical imaging system illustrated in FIG. 15; and

FIG. 17 is a block diagram of an optical imaging system according to a ninth embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

According to an example embodiment of the present disclosure, an optical imaging system may be mounted in a portable electronic device. For example, the optical imaging system may be a configuration of a camera module mounted on a portable electronic device. The portable electronic device may be a portable electronic device such as a mobile communication terminal, a smartphone, or a tablet PC.

In the example embodiments of the present disclosure, a first lens (or the forwardmost lens) refers to the lens closest to an object side, and a last lens (or a rearmost lens) refers to the lens closest to an imaging surface (or an image sensor).

Additionally, in each lens, a first surface denotes a surface close to the object side (or an object-side surface), and a second surface denotes a surface close to an image side (or an image-side surface). Additionally, in one or more example embodiments, the numerical values of the radius of curvature, thickness, distance, and focal length of the lens are all in mm units, and the unit of a field of view (FOV) is degrees.

Additionally, in the description of the shape of each lens, the disclosure that one surface is convex denotes that a paraxial region of the corresponding surface is convex, and the disclosure that the one surface is concave denotes that the paraxial region of the corresponding surface is concave.

Meanwhile, the paraxial region refers to a very narrow area near the optical axis.

The imaging surface may refer to a virtual surface on which the optical imaging system forms a focus. Alternatively, the imaging surface may refer to one surface of an image sensor on which light is received.

According to an example embodiment of the present disclosure, the optical imaging system includes a plurality of lens groups. For example, the optical imaging system may include a first lens group and a second lens group.

Each of the first lens group and the second lens group includes at least one lens. For example, the first lens group may include two or more lenses, and the second lens group may include four or more lenses. Accordingly, the optical imaging system includes at least six lenses. Each lens is spaced apart from each other by a predetermined distance.

In an example embodiment, the optical imaging system includes a first lens, a second lens, a third lens, a fourth lens, a fifth lens, and a sixth lens arranged in order from an object side.

According to an example embodiment of the present disclosure, the optical imaging system may include a reflective member having a reflective surface that changes an optical path. In an example, the reflective member may be a mirror or a prism.

By bending the optical path through the reflective member, the optical path may be elongated in a relatively narrow space.

Accordingly, while miniaturizing the optical imaging system, the optical imaging system may have a long focal length.

The reflective member may be disposed between the first lens group and the second lens group. In an example, the reflective member may be disposed between the first lens and the second lens.

The optical imaging system may further include an image sensor that converts an image of an incident subject into an electrical signal.

Additionally, the optical imaging system may further include an infrared blocking filter (hereinafter referred to as a ‘filter’) that blocks infrared rays. The filter may be disposed between the reflective member and the imaging surface.

Additionally, the optical imaging system may further include an aperture that adjusts the amount of light.

Both the lenses of the first lens group and the lenses of the second lens group may be made of plastic.

Each of the lenses of the first lens group and the lenses of the second lens group may have at least one aspherical surface.

According to an example embodiment of the present disclosure, the optical imaging system may satisfy at least one of the following conditional equations.

$$f 1 / f 2 < 0.2 \qquad [ Conditional Expression 1 ]$$

$$v 1 - v 2 > 29 \qquad [ Conditional Expression 2 ]$$

$$f > 10 mm \qquad [ Conditional Expression 3 ]$$

$$0.5 < DL 3 i / TTL < 0.6 \qquad [ Conditional Expression 4 ]$$

$$0 < DL 1 P / TTL < 0.25 \qquad [ Conditional Expression 5 ]$$

$$1 < f / fG 1 < 1.6 \qquad [ Conditional Expression 6 ]$$

$$0.4 \vert fG 1 / fG 2 \vert < 1.1 \qquad [ Conditional Expression 7 ]$$

$$0 < D 1 / f < 0.05 \qquad [ Conditional Expression 8 ]$$

$$2 < TTL / BFL < 6 \qquad [ Conditional Expression 9 ]$$

$$Nv 50 \geq 2 \qquad [ Conditional Expression 10 ]$$

$$Nv 28 \geq 3 \qquad [ Conditional Expression 11 ]$$

In the conditional expressions, f is a total focal length of the optical imaging system, f1 is a focal length of the first lens, f2 is a focal length of the second lens, fG1 is a focal length of the first lens group, and fG2 is a focal length of the second lens group.

Here, v1 is an Abbe number of the first lens, and v2 is an Abbe number of the second lens.

DL1 P is a distance on an optical axis from an object-side surface of the first lens to a first surface of the reflecting member, DL3i is a distance, on the optical axis, from an object-side surface of a forwardmost lens of the second lens group to an imaging surface, and D1 is a distance, on the optical axis, between the first lens and the second lens.

TTL is a distance, on the optical axis, from an object-side surface of the first lens to an imaging surface. BFL is a distance, on the optical axis, from an image-side surface of a rearmost lens of the second lens group to the imaging surface.

Nv50 is the number of lenses having an Abbe number greater than 50 among the plurality of lenses included in the optical imaging system, and Nv28 is the number of lenses with an Abbe number less than 28 among the plurality of lenses included in the optical imaging system.

The first lens group has positive refractive power as a whole. Additionally, light passing through the first lens group disposed in front of the reflective member may be refracted to converge and is incident on the reflective member.

In an example embodiment, the first lens group may include two lenses (e.g., a first lens and a second lens). One of the first lens and the second lens has a positive focal length, while the other has a negative focal length. The lens with the positive focal length has an Abbe number greater than 50, and the lens with the negative focal length may have an Abbe number less than 30.

For example, the first lens may have positive refractive power, and the second lens may have negative refractive power. Additionally, the Abbe number of the first lens may be greater than 50, and the Abbe number of the second lens may be less than 30.

An aperture may be disposed between the first lens group and the reflective member. For example, the aperture may be disposed between the second lens and the reflective member.

The second lens group includes four or more lenses and has positive or negative refractive power as a whole.

In an example embodiment, the second lens group includes a third lens, a fourth lens, a fifth lens, and a sixth lens. The third to sixth lenses may each have positive or negative refractive power.

One or more lenses included in the first lens group may be high-refractive index lenses. For example, when the first lens group includes two lenses, the lens having a larger absolute value of the focal length among the two lenses may be a high refractive lens. The high-refractive lens has a refractive index of 1.61 or more.

Additionally, the first lens and the second lens may be formed of materials with different optical properties. For example, the first lens may be a material with a great Abbe number, and the second lens may be a material with a smaller Abbe number than the first lens. Accordingly, chromatic aberration correction performance may be improved. For example, the first lens may have an Abbe number greater than 50, and the second lens may have an Abbe number less than 28.

The effective radii of the lenses included in the first lens group may be larger than the effective radii of the lenses included in the second lens group. Additionally, an effective radius of the first lens may be the largest among the lenses included in the optical imaging system. In an example embodiment, the effective radius of the first lens may be 2.5 mm or more.

Two or more lenses in the second lens group may be high-refractive. Two or more high-refractive lenses may be disposed in series. High-refractive lenses have a refractive index of 1.61 or more.

In an example embodiment, when the second lens group includes four lenses, each of the four lenses has a refractive index and an Abbe number different from the lenses disposed adjacent to each other.

The number of lenses included in the second lens group is equal to or greater than the number of lenses included in the first lens group.

According to an example embodiment of the present disclosure, the optical imaging system may have the characteristics of a telephoto lens with a relatively narrow angle of view (FOV) and a long focal length.

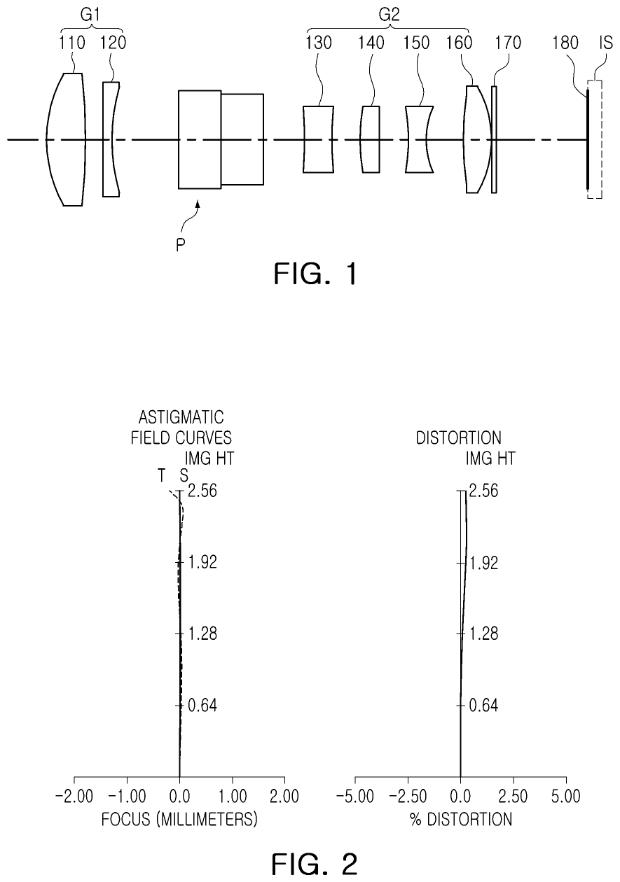

According to a first embodiment of the present disclosure, an optical imaging system will be described with reference to FIGS. 1 and 2.

According to the first embodiment of the present disclosure, the optical imaging system includes a first lens group G1, a reflective member P, and a second lens group G2.

The first lens group G1 includes a first lens 110 and a second lens 120, and the second lens group G2 includes a third lens 130, a fourth lens 140, a fifth lens 150, and a sixth lens 160.

Additionally, the optical imaging system may further include a filter 170 and an image sensor IS.

According to the first example embodiment of the present disclosure, the optical imaging system may form a focus on an imaging surface 180. The imaging surface 180 may denote a surface on which the optical imaging system forms a focus. In an example, the imaging surface 180 may denote one surface of the image sensor IS on which light is received.

The reflective member P may be disposed between the first lens 110 and the second lens 120 and may have a reflective surface that changes an optical path. The reflective member P may be a prism, but may be provided as a mirror.

The lens characteristics (a radius of curvature, a thickness of the lens, a distance between the lenses, an index of refraction, an Abbe number, and a focal length) of each lens are illustrated in Table 1.

TABLE 1

| Surface | | | Thickness or | | Abbe | Focal |
|---|---|---|---|---|---|---|
| Number | Division | Radius | Distance | Index | Number | Length |
| S1 | First Lens | 7.155 | 2.000 | 1.537 | 55.7 | 11.7555 |
| S2 | | −48.099 | 0.989 | | | |
| S3 | Second | −1000 | 0.500 | 1.621 | 26.0 | −17.2154 |
| | Lens | | | | | |
| S4 | | 10.801 | 2.947 | | | |
| S5 | Aperture | Infinity | 0.600 | | | |
| S6 | Reflective | Infinity | 2.250 | 1.839 | 37.3 | |
| | Member | | | | | |
| S7 | | Infinity | 2.250 | 1.839 | 37.3 | |
| S8 | | Infinity | 2.200 | | | |
| S9 | Third Lens | −174.75 | 1.500 | 1.547 | 56.1 | −64.7729 |
| S10 | | 44.525 | 1.500 | | | |
| S11 | Fourth Lens | 10.5101 | 1.000 | 1.668 | 20.4 | 13.7422 |
| S12 | | −70.0315 | 1.500 | | | |
| S13 | Fifth Lens | −18.3662 | 1.000 | 1.621 | 26.0 | −4.81095 |
| S14 | | 3.6396 | 2.000 | | | |
| S15 | Sixth Lens | 14.5873 | 1.492 | 1.547 | 56.1 | 7.92245 |
| S16 | | −5.93459 | 0.030 | | | |
| S17 | Filter | Infinity | 0.239 | 1.519 | 64.2 | |
| S18 | | Infinity | 4.904 | | | |
| S19 | Imaging | Infinity | | | | |
| | Surface | | | | | |

In an example, the total focal length f of the optical imaging system according to the first embodiment of the present disclosure is 27 mm, the focal length fG1 of the first lens group G1 is 25.614 mm, and the focal length fG2 of the second lens group G2 is 32 mm.

In the first embodiment of the present disclosure, the first lens 110 has positive refractive power, and a first surface and a second surface of the first lens 110 are convex.

The second lens 120 has negative refractive power, and a first surface and a second surface of the second lens 120 are concave.

The third lens 130 has negative refractive power, and a first surface and a second surface of the third lens 130 are concave.

The fourth lens 140 has positive refractive power, and a first surface and a second surface of the fourth lens 140 are convex.

The fifth lens 150 has negative refractive power, and a first surface and a second surface of the fifth lens 150 are concave.

The sixth lens 160 has positive refractive power, and a first surface and a second surface of the sixth lens 160 are convex.

Additionally, the optical imaging system configured as described above may have aberration characteristics illustrated in FIG. 2.

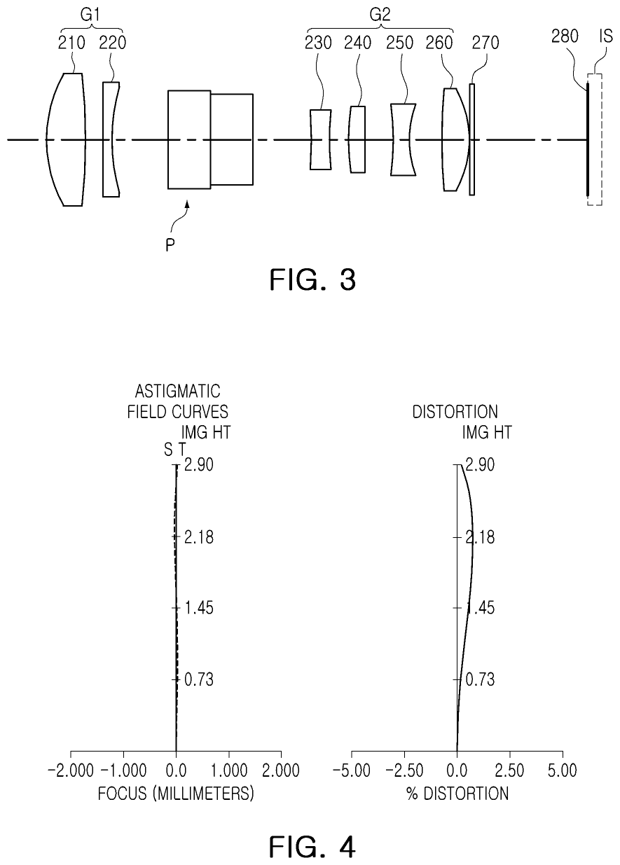

According to a second embodiment of the present disclosure, an optical imaging system will be described with reference to FIGS. 3 and 4.

According to the second embodiment of the present disclosure, the optical imaging system includes a first lens group G1, a reflective member P, and a second lens group G2.

The first lens group G1, includes a first lens 210 and a second lens 220. The second lens group G2, includes a third lens 230, a fourth lens 240, a fifth lens 250, and a sixth lens 260.

Additionally, the optical imaging system may further include a filter 270 and an image sensor IS.

According to the second embodiment of the present disclosure, the optical imaging system may form a focus on the imaging surface 280. The imaging surface 280 may refer to a surface on which the optical imaging system forms a focus. For example, the imaging surface 280 may refer to one surface of the image sensor IS on which light is received.

The reflective member P may be disposed between the first lens 210 and the second lens 220 and may have a reflective surface that changes the optical path. The reflective member P may be a prism, but may be provided as a mirror.

The lens characteristics (a radius of curvature, a thickness of the lens, a distance between the lenses, an index of refraction, an Abbe number, and a focal length) of each lens are illustrated in Table 2.

TABLE 2

| Surface | | | Thickness or | | Abbe | Focal |
|---|---|---|---|---|---|---|
| Number | Division | Radius | Distance | Index | Number | Length |
| S1 | First Lens | 6.826 | 2.000 | 1.537 | 55.7 | 11.0741 |
| S2 | | −41.225 | 0.992 | | | |
| S3 | Second | −1000 | 0.500 | 1.621 | 26.0 | −15.7296 |
| | Lens | | | | | |
| S4 | | 9.860 | 2.500 | | | |
| S5 | Aperture | Infinity | 0.600 | | | |
| S6 | Reflective | Infinity | 2.250 | 1.839 | 37.3 | |
| | Member | | | | | |
| S7 | | Infinity | 2.250 | 1.839 | 37.3 | |
| S8 | | Infinity | 3.000 | | | |
| S9 | Third Lens | −43.8989 | 1.000 | 1.547 | 56.1 | −19.6276 |
| S10 | | 14.3092 | 1.000 | | | |
| S11 | Fourth Lens | 6.66045 | 0.900 | 1.679 | 19.2 | 11.5736 |
| S12 | | 41.3387 | 1.500 | | | |
| S13 | Fifth Lens | −14.1823 | 0.900 | 1.646 | 23.5 | −5.50627 |
| S14 | | 4.86133 | 1.700 | | | |
| S15 | Sixth Lens | 19.7799 | 1.500 | 1.547 | 56.1 | 7.92084 |
| S16 | | −5.39297 | 0.030 | | | |
| S17 | Filter | Infinity | 0.239 | 1.519 | 64.2 | |
| S18 | | Infinity | 6.039 | | | |
| S19 | Imaging | Infinity | | | | |
| | Surface | | | | | |

In an example, a total focal length f of the optical imaging system according to the second embodiment of the present disclosure is 27 mm, the focal length fG1 of the first lens group G1 is 24.583 mm, and the focal length fG2 of the second lens group G2 is 32 mm.

In the second embodiment of the present disclosure, the first lens 210 has positive refractive power, and a first surface and a second surface of the first lens 210 are convex.

The second lens 220 has negative refractive power, and a first surface and a second surface of the second lens 220 are concave.

The third lens 230 has negative refractive power, and a first surface and a second surface of the third lens 230 are concave.

The fourth lens 240 has positive refractive power, a first surface of the fourth lens 240 is convex, and a second surface of the fourth lens 240 is concave.

The fifth lens 250 has negative refractive power, and a first surface and a second surface of the fifth lens 250 are concave.

The sixth lens 260 has positive refractive power, and a first surface and a second surface of the sixth lens 260 are convex.

Additionally, the optical imaging system configured as described above may have aberration characteristics, as illustrated in FIG. 4.

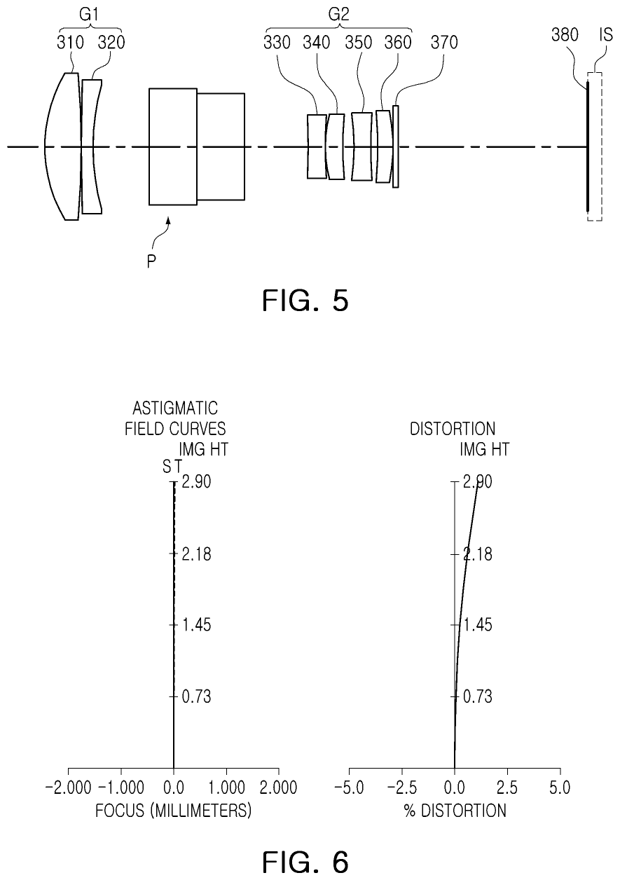

According to a third embodiment of the present disclosure, an optical imaging system will be described with reference to FIGS. 5 and 6.

According to the third embodiment of the present disclosure, the optical imaging system includes a first lens group G1, a reflective member P, and a second lens group G2.

The first lens group G1 includes a first lens 310 and a second lens 320, and the second lens group G2 includes a third lens 330, a fourth lens 340, a fifth lens 350, and a sixth lens 360.

Additionally, the optical imaging system may further include a filter 370 and an image sensor IS.

According to the third embodiment of the present disclosure, the optical imaging system may form a focus on an imaging surface 380. The imaging surface 380 may denote a surface on which the optical imaging system forms a focus. In an example, the imaging surface 380 may denote one surface of the image sensor IS on which light is received.

The reflective member P may be disposed between the first lens 310 and the second lens 320 and may have a reflective surface that changes an optical path. The reflective member P may be a prism, but may be provided as a mirror.

The lens characteristics (a radius of curvature, a thickness of the lens, a distance between the lenses, an index of refraction, an Abbe number, and a focal length) of each lens are illustrated in Table 3.

TABLE 3

| Surface | | | Thickness or | | Abbe | Focal |
|---|---|---|---|---|---|---|
| Number | Division | Radius | Distance | Index | Number | Length |
| S1 | First Lens | 6.298 | 1.681 | 1.537 | 55.7 | 10.5918 |
| S2 | | −53.405 | 0.030 | | | |
| S3 | Second | 83.208 | 0.583 | 1.620 | 25.9 | −19.666 |
| | Lens | | | | | |
| S4 | | 10.606 | 2.000 | | | |
| S5 | Aperture | Infinity | 0.600 | | | |
| S6 | Reflective | Infinity | 2.250 | 1.839 | 37.3 | |
| | Member | | | | | |
| S7 | | Infinity | 2.250 | 1.839 | 37.3 | |
| S8 | | Infinity | 3.000 | | | |
| S9 | Third Lens | −63.6978 | 0.800 | 1.547 | 56.1 | −18.6265 |
| S10 | | 12.1693 | 0.030 | | | |
| S11 | Fourth Lens | 6.09666 | 0.800 | 1.679 | 19.2 | 13.3479 |
| S12 | | 17.6438 | 0.523 | | | |
| S13 | Fifth Lens | −12.0755 | 0.800 | 1.646 | 23.5 | −8.85301 |
| S14 | | 11.1322 | 0.300 | | | |
| S15 | Sixth Lens | −33.2003 | 0.730 | 1.537 | 55.7 | 19.4553 |
| S16 | | −8.00941 | 0.030 | | | |
| S17 | Filter | Infinity | 0.239 | 1.519 | 64.2 | |
| S18 | | Infinity | 8.907 | | | |
| S19 | Imaging | Infinity | | | | |
| | Surface | | | | | |

In an example, a total focal length f of the optical imaging system according to the third embodiment of the present disclosure is 27 mm, the focal length fG1 of the first lens group G1 is 19.828 mm, and the focal length fG2 of the second lens group G2 is −30.002 mm.

In the third embodiment of the present disclosure, the first lens 310 has positive refractive power, and a first surface and a second surface of the first lens 310 are convex.

The second lens 320 has negative refractive power, a first surface of the second lens 320 is convex, and a second surface of the second lens 320 is concave.

The third lens 330 has negative refractive power, and a first surface and a second surface of the third lens 330 are concave.

The fourth lens 340 has positive refractive power, a first surface of the fourth lens 340 is convex, and a second surface of the fourth lens 340 is concave.

The fifth lens 350 has negative refractive power, and a first surface and a second surface of the fifth lens 350 are concave.

The sixth lens 360 has positive refractive power, a first surface of the sixth lens 360 is concave, and a second surface of the sixth lens 360 is convex.

Additionally, the optical imaging system configured as described above may have aberration characteristics illustrated in FIG. 6.

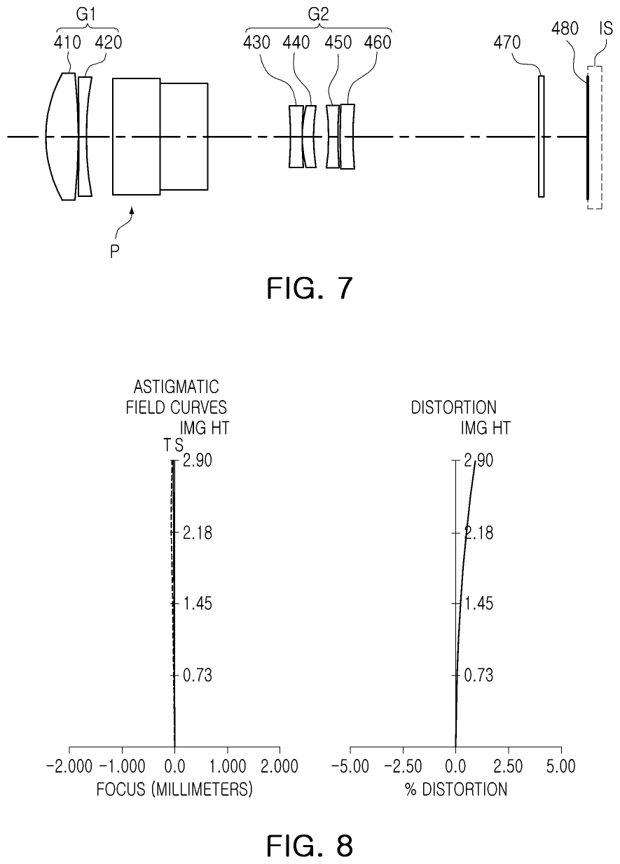

According to a fourth embodiment of the present disclosure, an optical imaging system will be described with reference to FIGS. 7 and 8.

According to the fourth embodiment of the present disclosure, the optical imaging system includes a first lens group G1, a reflective member P, and a second lens group G2.

The first lens group G1, includes a first lens 410 and a second lens 420. The second lens group G2, includes a third lens 430, a fourth lens 440, a fifth lens 450, and a sixth lens 460.

Additionally, the optical imaging system may further include a filter 470 and an image sensor IS.

According to the fourth embodiment of the present disclosure, the optical imaging system may form a focus on an imaging surface 480. The imaging surface 480 may denote a surface on which the optical imaging system forms a focus. In an example, the imaging surface 480 may denote one surface of the image sensor IS on which light is received.

The reflective member P may be disposed between the first lens 410 and the second lens 420 and may have a reflective surface that changes an optical path. The reflective member P may be a prism, but may be provided as a mirror.

The lens characteristics (a radius of curvature, a thickness of the lens, a distance between the lenses, an index of refraction, an Abbe number, and a focal length) of each lens are shown in Table 4.

TABLE 4

| Surface | | | Thickness or | | Abbe | Focal |
|---|---|---|---|---|---|---|
| Number | Division | Radius | Distance | Index | Number | Length |
| S1 | First Lens | 6.380 | 1.500 | 1.537 | 55.7 | 10.4704 |
| S2 | | −43.554 | 0.050 | | | |
| S3 | Second | −212.881 | 0.400 | 1.620 | 25.9 | −20.2702 |
| | Lens | | | | | |
| S4 | | 13.366 | 0.700 | | | |
| S5 | Aperture | Infinity | 0.600 | | | |
| S6 | Reflective | Infinity | 2.250 | 1.839 | 37.3 | |
| | Member | | | | | |
| S7 | | Infinity | 2.250 | 1.839 | 37.3 | |
| S8 | | Infinity | 4.000 | | | |
| S9 | Third Lens | 321.729 | 0.600 | 1.547 | 56.1 | −24.9354 |
| S10 | | 13.0649 | 0.050 | | | |
| S11 | Fourth Lens | 6.4942 | 0.500 | 1.668 | 20.4 | 18.2948 |
| S12 | | 13.4237 | 0.721 | | | |
| S13 | Fifth Lens | −25.9449 | 0.500 | 1.646 | 23.5 | −15.6939 |
| S14 | | 16.7475 | 0.095 | | | |
| S15 | Sixth Lens | 42.3309 | 0.600 | 1.537 | 55.7 | −261.635 |
| S16 | | 32.3707 | 9.000 | | | |
| S17 | Filter | Infinity | 0.210 | 1.519 | 64.2 | |
| S18 | | Infinity | 2.154 | | | |
| S19 | Imaging | Infinity | | | | |
| | Surface | | | | | |

In an example, a total focal length f of the optical imaging system according to the fourth embodiment of the present disclosure is 30.6331 mm, the focal length fG1 of the first lens group G1 is 19.396 mm, and the focal length fG2 of the second lens group G2 is −19.299 mm.

In the fourth embodiment of the present disclosure, the first lens 410 has positive refractive power, and a first surface and a second surface of the first lens 410 are convex.

The second lens 420 has negative refractive power, and a first surface and a second surface of the second lens 420 are concave.

The third lens 430 has negative refractive power, a first surface of the third lens 430 is convex, and a second surface of the third lens 430 is concave.

The fourth lens 440 has positive refractive power, a first surface of the fourth lens 440 is convex, and a second surface of the fourth lens 440 is concave.

The fifth lens 450 has negative refractive power, and a first surface and a second surface of the fifth lens 450 are concave.

The sixth lens 460 has negative refractive power, a first surface of the sixth lens 460 is convex, and a second surface of the sixth lens 460 is concave.

Additionally, the optical imaging system configured as described above may have aberration characteristics illustrated in FIG. 8.

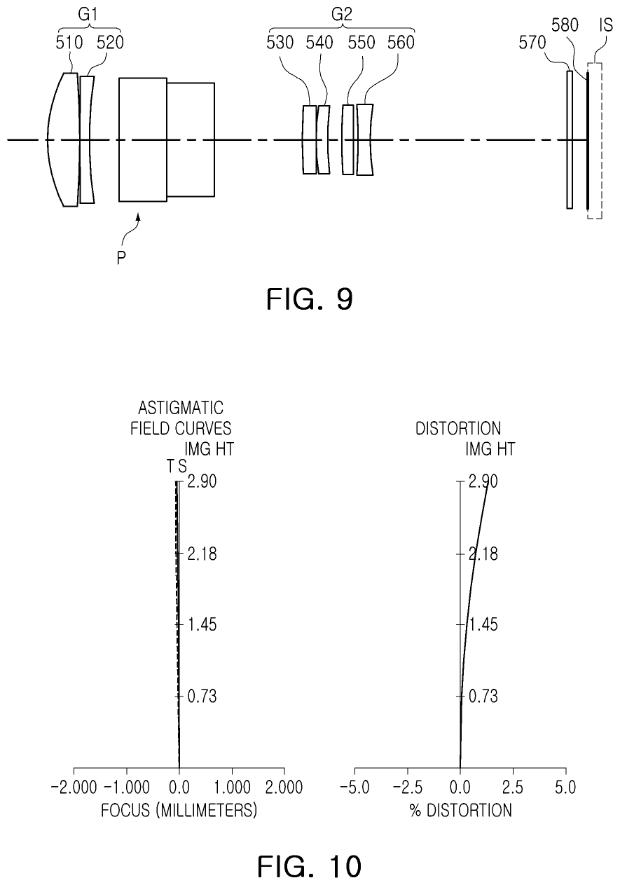

According to a fifth embodiment of the present disclosure, an optical imaging system will be described with reference to FIGS. 9 and 10.

According to the fifth embodiment of the present disclosure, the optical imaging system includes a first lens group G1, a reflective member P, and a second lens group G2.

The first lens group G1, includes a first lens 510 and a second lens 520. The second lens group G2, includes a third lens 530, a fourth lens 540, a fifth lens 550, and a sixth lens 560.

Additionally, the optical imaging system may further include a filter 570 and an image sensor IS.

According to the fifth embodiment of the present disclosure, the optical imaging system may form a focus on an imaging surface 580. The imaging surface 580 may denote a surface on which the optical imaging system forms a focus. In an example, the imaging surface 580 may denote one surface of an image sensor IS through which light is received.

The reflective member P may be disposed between the first lens 510 and the second lens 520 and may have a reflective surface that changes an optical path. The reflective member P may be a prism, but may be provided as a mirror.

The lens characteristics (a radius of curvature, a thickness of the lens, a distance between the lenses, an index of refraction, an Abbe number, and a focal length) of each lens are illustrated in Table 5.

TABLE 5

| Surface | | | Thickness or | | Abbe | Focal |
|---|---|---|---|---|---|---|
| Number | Division | Radius | Distance | Index | Number | Length |
| S1 | First Lens | 6.652 | 1.450 | 1.537 | 55.7 | 11.0638 |
| S2 | | −51.524 | 0.050 | | | |
| S3 | Second | 1952.58 | 0.400 | 1.620 | 25.9 | −22.1856 |
| | Lens | | | | | |
| S4 | | 13.658 | 0.700 | | | |
| S5 | Aperture | Infinity | 0.600 | | | |
| S6 | Reflective | Infinity | 2.250 | 1.839 | 37.3 | |
| | Member | | | | | |
| S7 | | Infinity | 2.250 | 1.839 | 37.3 | |
| S8 | | Infinity | 4.000 | | | |
| S9 | Third Lens | 47.2812 | 0.600 | 1.547 | 56.1 | 90.7897 |
| S10 | | 1000 | 0.050 | | | |
| S11 | Fourth Lens | 11.0308 | 0.500 | 1.668 | 20.4 | 68.9032 |
| S12 | | 14.242 | 0.666 | | | |
| S13 | Fifth Lens | 113.654 | 0.500 | 1.620 | 25.9 | −83.1146 |
| S14 | | 35.3965 | 0.202 | | | |
| S15 | Sixth Lens | −18.8479 | 0.600 | 1.537 | 55.7 | −17.2427 |
| S16 | | 18.4127 | 9.000 | | | |
| S17 | Filter | Infinity | 0.210 | 1.519 | 64.2 | |
| S18 | | Infinity | 0.765 | | | |
| S19 | Imaging | Infinity | | | | |
| | Surface | | | | | |

In an example, a total focal length f of the optical imaging system according to the fifth embodiment of the present disclosure is 27 mm, the focal length fG1 of the first lens group G1 is 20.016 mm, and the focal length fG2 of the second lens group G2 is −24.780 mm.

In the fifth embodiment of the present disclosure, the first lens 510 has positive refractive power, and a first surface and a second surface of the first lens 510 are convex.

The second lens 520 has negative refractive power, a first surface of the second lens 520 is convex, and a second surface of the second lens 520 is concave.

The third lens 530 has positive refractive power, a first surface of the third lens 530 is convex, and a second surface of the third lens 530 is concave.

The fourth lens 540 has positive refractive power, a first surface of the fourth lens 540 is convex, and a second surface of the fourth lens 540 is concave.

The fifth lens 550 has negative refractive power, a first surface of the fifth lens 550 is convex, and a second surface of the fifth lens 550 is concave.

The sixth lens 560 has negative refractive power, and a first surface and a second surface of the sixth lens 560 is concave.

Additionally, the optical imaging system configured as described above may have aberration characteristics illustrated in FIG. 10.

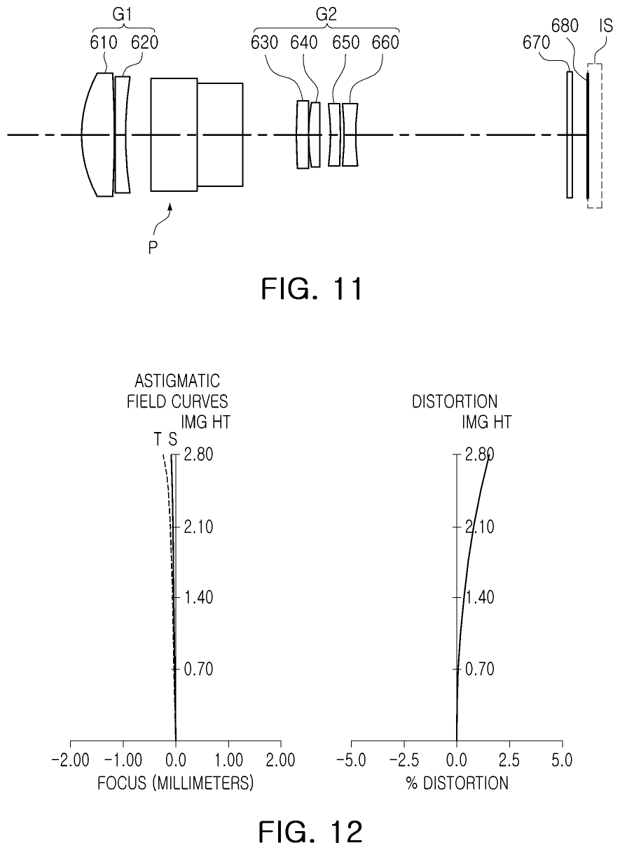

According to a sixth embodiment of the present disclosure, an optical imaging system will be described with reference to FIGS. 11 and 12.

According to the sixth embodiment of the present disclosure, the optical imaging system includes a first lens group G1, a reflective member P, and a second lens group G2.

The first lens group G1, includes a first lens 610 and a second lens 620, and the second lens group G2, includes a third lens 630, a fourth lens 640, a fifth lens 650, and a sixth lens 660.

Additionally, the optical imaging system may further include a filter 670 and an image sensor IS.

According to the sixth embodiment of the present disclosure, the optical imaging system may form a focus on an imaging surface 680. The imaging surface 680 may denote a surface on which the optical imaging system forms a focus. In an example, the imaging surface 680 may denote one surface of the image sensor IS on which light is received.

The reflective member P may be disposed between the first lens 610 and the second lens 620 and may have a reflective surface that changes an optical path. The reflective member P may be a prism, but may be provided as a mirror.

The lens characteristics (a radius of curvature, a thickness of the lens, a distance between the lenses, an index of refraction, an Abbe number, and a focal length) of each lens are illustrated in Table 6.

TABLE 6

| Surface | | | Thickness or | | Abbe | Focal |
|---|---|---|---|---|---|---|
| Number | Division | Radius | Distance | Index | Number | Length |
| S1 | First Lens | 6.650 | 1.600 | 1.537 | 55.7 | 11.0367 |
| S2 | | −50.002 | 0.041 | | | |
| S3 | Second | 999.322 | 0.450 | 1.620 | 25.9 | −22.9025 |
| | Lens | | | | | |
| S4 | | 13.999 | 0.700 | | | |
| S5 | Aperture | Infinity | 0.600 | | | |
| S6 | Reflective | Infinity | 2.250 | 1.839 | 37.3 | |
| | Member | | | | | |
| S7 | | Infinity | 2.250 | 1.839 | 37.3 | |
| S8 | | Infinity | 2.650 | | | |
| S9 | Third Lens | 31.9695 | 0.600 | 1.547 | 56.1 | 60.4196 |
| S10 | | 998.878 | 0.030 | | | |
| S11 | Fourth Lens | 19.1782 | 0.500 | 1.668 | 20.4 | 28.7932 |
| S12 | | 5602.04 | 0.500 | | | |
| S13 | Fifth Lens | −17.8832 | 0.500 | 1.646 | 23.5 | −22.6897 |
| S14 | | 81.8382 | 0.190 | | | |
| S15 | Sixth Lens | −20.4728 | 0.600 | 1.537 | 55.7 | −19.1768 |
| S16 | | 20.9437 | 10.350 | | | |
| S17 | Filter | Infinity | 0.210 | 1.519 | 64.2 | |
| S18 | | Infinity | 0.775 | | | |
| S19 | Imaging | Infinity | | | | |
| | Surface | | | | | |

In an example, a total focal length f of the optical imaging system according to the sixth embodiment of the present disclosure is 27.01 mm, the focal length fG1 of the first lens group G1 is 19.270 mm, and the focal length fG2 of the second lens group G2 is −25 mm.

In the sixth embodiment of the present disclosure, the first lens 610 has positive refractive power, and a first surface and a second surface of the first lens 610 are convex.

The second lens 620 has negative refractive power, a first surface of the second lens 620 is convex, and a second surface of the second lens 620 is concave.

The third lens 630 has positive refractive power, a first surface of the third lens 630 is convex, and a second surface of the third lens 630 is concave.

The fourth lens 640 has positive refractive power, a first surface of the fourth lens 640 is convex, and a second surface of the fourth lens 640 is concave.

The fifth lens 650 has negative refractive power, and a first surface and a second surface of the fifth lens 650 are concave.

The sixth lens 660 has negative refractive power, and a first surface and a second surface of the sixth lens 660 are concave.

Additionally, the optical imaging system configured as described above may have aberration characteristics illustrated in FIG. 12.

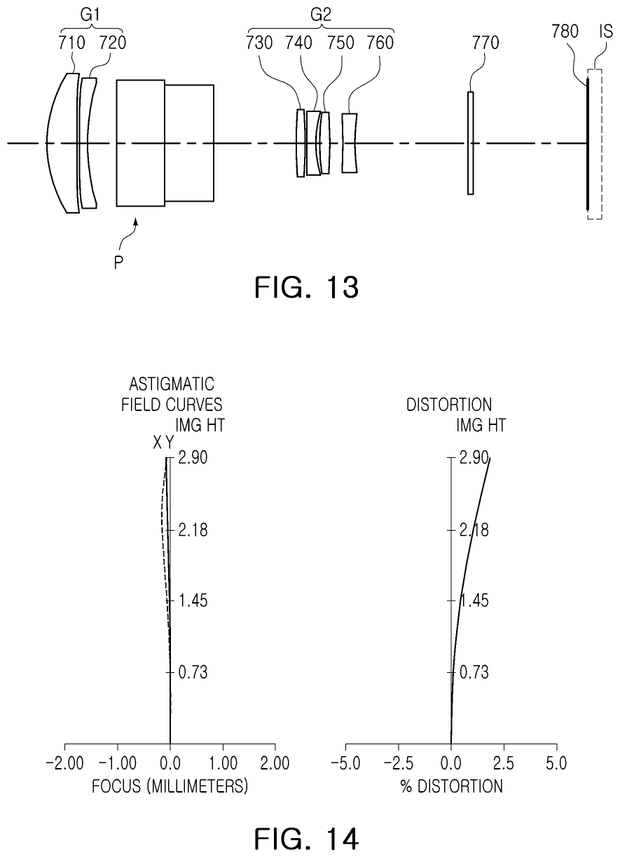

According to a seventh embodiment of the present disclosure, an optical imaging system will be described with reference to FIGS. 13 and 14.

According to the seventh embodiment of the present disclosure, the optical imaging system includes a first lens group G1, a reflective member P, and a second lens group G2.

The first lens group G1, includes a first lens 710 and a second lens 720, and the second lens group G2 includes a third lens 730, a fourth lens 740, a fifth lens 750, and a sixth lens 760.

Additionally, the optical imaging system may further include a filter 770 and an image sensor IS.

According to the seventh embodiment of the present disclosure, the optical imaging system may form a focus on an imaging surface 780. The imaging surface 780 may denote a surface on which the optical imaging system forms a focus. In an example, the imaging surface 780 may mean one surface of the image sensor IS on which light is received.

The reflective member P may be disposed between the first lens 710 and the second lens 720 and may have a reflective surface that changes an optical path. The reflective member P may be a prism, but may be provided as a mirror.

The characteristics (a radius of curvature, a thickness of the lens, a distance between the lenses, an index of refraction, an Abbe number, and a focal length) of each lens are illustrated in Table 7.

TABLE 7

| Surface | | | Thickness or | | Abbe | Focal |
|---|---|---|---|---|---|---|
| Number | Division | Radius | Distance | Index | Number | Length |
| S1 | First Lens | 6.231 | 1.450 | 1.537 | 55.7 | 11.6144 |
| S2 | | 5000 | 0.100 | | | |
| S3 | Second | 100 | 0.350 | 1.620 | 25.9 | −25.0889 |
| | Lens | | | | | |
| S4 | | 13.444 | 0.700 | | | |
| S5 | Aperture | Infinity | 0.600 | | | |
| S6 | Reflective | Infinity | 2.250 | 1.839 | 37.3 | |
| | Member | | | | | |
| S7 | | Infinity | 2.250 | 1.839 | 37.3 | |
| S8 | | Infinity | 3.797 | | | |
| S9 | Third Lens | 25 | 0.400 | 1.547 | 56.1 | 25.0165 |
| S10 | | −30 | 0.095 | | | |
| S11 | Fourth Lens | −223.324 | 0.400 | 1.646 | 23.5 | −8.18421 |
| S12 | | 5.41514 | 0.164 | | | |
| S13 | Fifth Lens | 7.02667 | 0.469 | 1.668 | 20.4 | 10.4424 |
| S14 | | −1000 | 0.600 | | | |
| S15 | Sixth Lens | −1000 | 0.585 | 1.537 | 55.7 | −18.6077 |
| S16 | | 10.0979 | 5.203 | | | |
| S17 | Filter | Infinity | 0.210 | 1.519 | 64.2 | |
| S18 | | Infinity | 5.274 | | | |
| S19 | Imaging | Infinity | | | | |
| | Surface | | | | | |

In an example, a total focal length f of the optical imaging system according to the seventh embodiment of the present disclosure is 27.01 mm, the focal length fG1 of the first lens group G1 is 19.730 mm, and the focal length fG2 of the second lens group G2 is −26.984 mm.

In the seventh embodiment of the present disclosure, the first lens 710 has positive refractive power, a first surface of the first lens 710 is convex, and a second surface of the first lens 710 is concave.

The second lens 720 has negative refractive power, a first surface of the second lens 720 is convex, and a second surface of the second lens 720 is concave.

The third lens 730 has positive refractive power, and a first surface and a second surface of the third lens 730 are convex.

The fourth lens 740 has negative refractive power, and a first surface and a second surface of the fourth lens 740 are concave.

The fifth lens 750 has positive refractive power, and a first surface and a second surface of the fifth lens 750 are convex.

The sixth lens 760 has negative refractive power, and a first surface and a second surface of the sixth lens 760 are concave.

Additionally, the optical imaging system configured as described above may have aberration characteristics shown in FIG. 14.

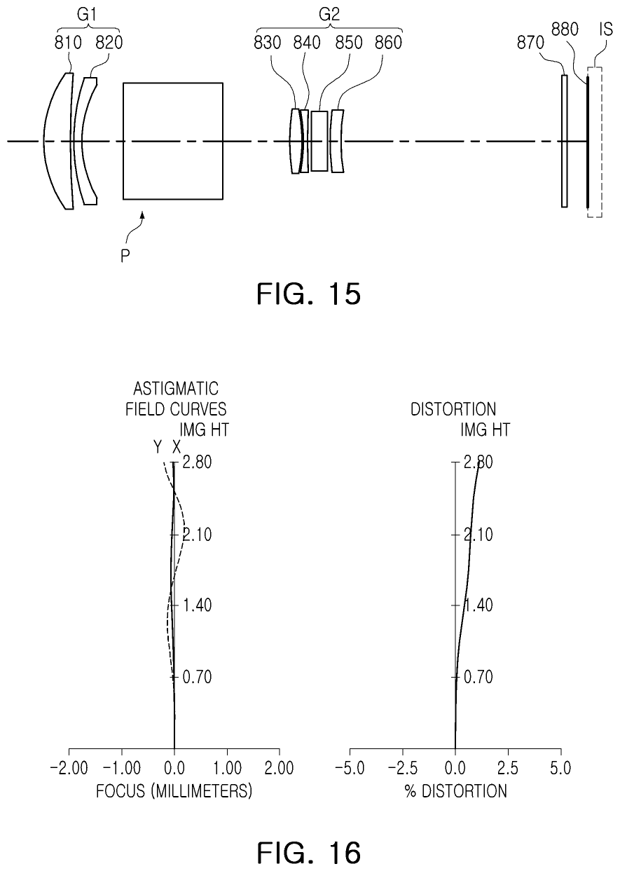

According to an eighth embodiment of the present disclosure, an optical imaging system will be described with reference to FIGS. 15 and 16.

The optical imaging system according to the eighth embodiment of the present disclosure includes a first lens group G1, a reflective member P, and a second lens group G2.

The first lens group G1, includes a first lens 810 and a second lens 820. The second lens group G2, includes a third lens 830, a fourth lens 840, a fifth lens 850, and a sixth lens 860.

Additionally, the optical imaging system may further include a filter 870 and an image sensor IS.

According to the eighth embodiment of the present disclosure, the optical imaging system may form a focus on an imaging surface 880. The imaging surface 880 may denote a surface on which the optical imaging system forms a focus. For example, the imaging surface 880 may denote one surface of the image sensor IS on which light is received.

The reflective member P may be disposed between the first lens 810 and the second lens 820 and may have a reflective surface that changes an optical path. The reflective member P may be a mirror, but may be provided as a prism.

The lens characteristics (a radius of curvature, a thickness of the lens, a distance between the lenses, an index of refraction, an Abbe number, and a focal length) of each lens are illustrated in Table 8.

TABLE 8

| Surface | | | Thickness or | | Abbe | Focal |
|---|---|---|---|---|---|---|
| Number | Division | Radius | Distance | Index | Number | Length |
| S1 | First Lens | 5.229 | 1.239 | 1.546 | 55.9 | 10.5381 |
| S2 | | 52.2183 | 0.100 | | | |
| S3 | Second | 9.06676 | 0.349 | 1.620 | 26.0 | −18.4289 |
| | Lens | | | | | |
| S4 | | 4.981 | 1.228 | | | |
| S5 | Aperture | Infinity | 0.655 | | | |
| S6 | Reflective | Infinity | 4.500 | 1.839 | 37.3 | |
| | Member | | | | | |
| S7 | | Infinity | 3.111 | | | |
| S8 | Third Lens | 18.421 | 0.480 | 1.668 | 20.4 | 9.5429306 |
| S9 | | −9.65374 | 0.100 | | | |
| S10 | Fourth Lens | −5.82817 | 0.186 | 1.646 | 23.5 | −9.303431 |
| S11 | | −199.646 | 0.165 | | | |
| S12 | Fifth Lens | −55.9976 | 0.730 | 1.620 | 26.0 | −51.69939 |
| S13 | | 75.3455 | 0.137 | | | |
| S14 | Sixth Lens | 11.5176 | 0.470 | 1.546 | 55.9 | −221.0383 |
| S15 | | 10.3631 | 10.000 | | | |
| S17 | Filter | Infinity | 0.210 | 1.519 | 64.2 | |
| S18 | | Infinity | 0.922 | | | |
| S19 | Imaging | Infinity | | | | |
| | Surface | | | | | |

In an example, a total focal length f of the optical imaging system according to the eighth embodiment of the present disclosure is 25.8467 mm, the focal length fG1 of the first lens group G1 is 20.734 mm, and the focal length fG2 of the second lens group G2 is −41.298 mm.

In the eighth embodiment of the present disclosure, the first lens 810 has positive refractive power, a first surface of the first lens 810 is convex, and a second surface of the first lens 810 is concave.

The second lens 820 has negative refractive power, a first surface of the second lens 820 is convex, and a second surface of the second lens 820 is concave.

The third lens 830 has positive refractive power, and a first surface and a second surface of the third lens 830 is convex.

The fourth lens 840 has negative refractive power, a first surface of the fourth lens 840 is concave, and a second surface of the fourth lens 840 is convex.

The fifth lens 850 has negative refractive power, and a first surface and a second surface of the fifth lens 850 are concave.

The sixth lens 860 has negative refractive power, a first surface of the sixth lens 860 is convex, and a second surface of the sixth lens 860 is concave.

Additionally, the optical imaging system configured as described above may have aberration characteristics illustrated in FIG. 16.

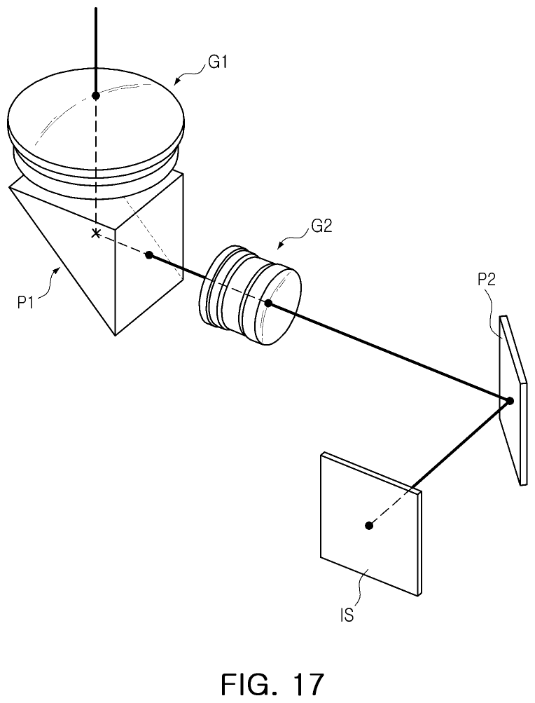

An optical imaging system according to a ninth embodiment of the present disclosure will be described with reference to FIG. 17.

According to the ninth embodiment of the present disclosure, the optical imaging system includes a first lens group G1, a first reflective member P1, a second lens group G2, and a second reflective member P2.

The first lens group G1 and the second lens group G2 may be the first lens group G1 and the second lens group G2 according to any one of the first to eighth embodiments.

In this embodiment, the first reflective member P1 may be disposed between the first lens group G1 and the second lens group G2. The second reflective member P2 may be disposed between the second lens group G2 and the image sensor IS.

When an optical axis of the first lens group G1 is defined as a first optical axis, an optical axis of the second lens group G2 is defined as a second optical axis, and an optical axis in which light reflected from the second reflective member P2 reaches the image sensor IS is defined as a third optical axis, the first optical axis and the second optical axis are perpendicular to each other, and the second optical axis and the third optical axis are perpendicular to each other.

An aspect of the present disclosure is to provide an optical imaging system having a small size and capable of implementing high resolution. In an optical imaging system according to an example embodiment of the present disclosure, the size of the optical imaging system may be reduced and a high-resolution image may be captured.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system, comprising:
a first lens group, a reflective member, and a second lens group sequentially arranged along an optical axis,
wherein each of the first lens group and the second lens group includes a plurality of lenses,
the first lens group has positive refractive power,
an effective diameter of a first lens, among the plurality of lenses in the first lens group, is largest among the plurality of lenses in the first and second lens groups, and
wherein 0<DL1 P/TTL<0.25 is satisfied, where DL1P is a distance, on the optical axis, from an object-side surface of the first lens in the first lens group to a first surface of the reflective member, and TTL is a distance, on the optical axis, from the object-side surface of the first lens in the first lens group to an imaging surface.

2. The optical imaging system of claim 1, wherein the first lens group comprises the first lens and a second lens arranged sequentially from an object side,
one of the first lens and the second lens has a positive focal length with an Abbe number greater than 50, and another has a negative focal length with an Abbe number less than 30.

3. The optical imaging system of claim 2, wherein v1−v2>29 is satisfied, where v1 is the Abbe number of the first lens, and v2 is the Abbe number of the second lens.

4. The optical imaging system of claim 1, wherein the first lens group comprises the first lens and a second lens arranged sequentially from an object side, and
f1/f2<0.2 is satisfied, where f1 is a focal length of the first lens, and f2 is a focal length of the second lens.

5. The optical imaging system of claim 4, wherein 0<D1/f<0.05 is satisfied, where D1 is a distance, on the optical axis, between the first lens and the second lens.

6. The optical imaging system of claim 1, wherein f>10 mm is satisfied, where f is a total focal length of the optical imaging system.

7. The optical imaging system of claim 1, wherein 0.5<DL3i/TTL<0.6 is satisfied, where DL3i is a distance, on the optical axis, from an object-side surface of a forwardmost lens of the second lens group to the imaging surface.

8. The optical imaging system of claim 1, wherein 2<TTL/BFL<6 is satisfied, where BFL is a distance, on the optical axis, from an image-side surface of a rearmost lens of the plurality of lenses in the second lens group to the imaging surface.

9. The optical imaging system of claim 1, wherein 1<f/fG1<1.6 is satisfied, where f is a total focal length of the optical imaging system, and fG1 is a focal length of the first lens group.

10. The optical imaging system of claim 1, wherein 0.4<|fG1/fG2|<1.1 is satisfied, where fG1 is a focal length of the first lens group, and fG2 is a focal length of the second lens group.

11. The optical imaging system of claim 1, wherein Nv50≥2 and Nv28≥3 are satisfied, where Nv50 is a number of lenses having an Abbe number greater than 50, and Nv28 is a number of lenses having an Abbe number less than 28.

12. The optical imaging system of claim 11, wherein among the plurality of lenses in the second lens group, two or more lenses arranged sequentially from the object side have a refractive index of 1.61 or more.

13. The optical imaging system of claim 1, wherein a number of the plurality of lenses in the second lens group is equal to or greater than a number of the plurality of lenses in the first lens group.

14. The optical imaging system of claim 13, wherein the first lens group comprises the first lens and a second lens, and the second lens group comprises a third lens, a fourth lens, a fifth lens and a sixth lens, and
the first lens has positive refractive power, and the second lens has negative refractive power.

15. An optical imaging system, comprising:
a first lens group comprising a first lens and a second lens;
a reflective member; and
a second lens group comprising a third lens, a fourth lens, a fifth lens and a sixth lens,
wherein the first lens group, the reflective member, and the second lens group are sequentially arranged along an optical axis,
wherein the first lens has positive refractive power, and the second lens has negative refractive power,
wherein an effective diameter of the first lens is largest among lenses of the first and second lens groups,
wherein 0<DL1 P/TTL<0.25 is satisfied, where DL1P is a distance, on the optical axis, from an object-side surface of the first lens to a first surface of the reflective member, and TTL is a distance, on the optical axis, from the object-side surface of the first lens to an imaging surface, and
wherein 2<TTL/BFL<6 is satisfied, where BFL is a distance, on the optical axis, from an image-side surface of a rearmost lens of the plurality of lenses in the second lens group to the imaging surface.

16. The optical imaging system of claim 15, wherein v1−v2>29 is satisfied, where v1 is an Abbe number of the first lens, and v2 is an Abbe number of the second lens.

17. The optical imaging system of claim 15, wherein f1/f2<0.2 is satisfied, where f1 is a focal length of the first lens, and f2 is a focal length of the second lens.
